(19) United States
(12) Patent Application Publication
(10) Pub. No.: US 2010/0162798 A1
(43) Pub. Date: Jul. 1, 2010

(54) Method for Determining the Viscosity of Fluids, and Viscosimeter

(75) Inventor: Josef Gautsch, Graz (AT)

Correspondence Address: LERNER GREENBERG STEMER LLP, P O BOX 2480, HOLLYWOOD, FL, 33022-2480, US

(73) Assignee: ANTON PAAR GMBH, Graz (AT)

(21) Appl. No.: 12/663,315

(22) PCT Filed: Apr. 22, 2008
(86) PCT No.: PCT/AT2008/000146

§ 371 Date: Mar. 17, 2010

(30) Foreign Application Priority Data
Jun. 6, 2007 (AT) A 893/2007

(51) Int. Cl. G01N 11/14

(52) U.S. Cl. 73/54.28

(57) ABSTRACT

In a method for determining the viscosity of fluids, especially liquids, the fluid is brought into and moved through a tapering gap bounded by two opposite wall surfaces. Accordingly, a distance or the change of the distance between the opposite wall surfaces is measured by pressure exerted by the material moved through the preferably steadily tapering or narrowing gap onto the walls and is used or evaluated as a measurement value for the viscosity of the fluid.

The invention relates to a method in accordance with the generic term of Patent Claim 1. Furthermore, the invention relates to a viscosimeter in accordance with the generic term of Patent Claim 5.

The measurement of rheological magnitudes is based on the knowledge of the correlation between shearing stress and the deformation of the material to be examined.

In addition to known principles such as, e.g. falling sphere viscosimeters, the dynamic viscosity of a fluid can be generally determined by means of measuring the friction during the movement of two bodies of known geometry against each other.

The so-called rotation viscosimeters are each based in their varying known embodiments on the measurement of the torque or momentum change of the rotating body through the viscous fluid. In practice, a gauging member of known geometry is moved in a (resting or moved) fluid and the viscosity is determined for example by means of a rotation measuring tape or the power consumption of the drive, see e.g. DE 10047793 A1.

Various methods have been developed for in-line use in a chemically aggressive environment. WO9941586 suggests, for example, determining the viscosity based on the torque variation of the agitator during the manufacture of synthetic resins. In order to be able to make any conclusions with regard to the viscosity based on this value, the portion of the overall dissipation loss of the drive caused by the friction of the fluid or, respectively, by the viscosity must be known and relatively low; the technical embodiments try to keep the friction losses caused by the drive or, respectively, by the design, e.g. air suspension or magnetic suspension of the rotor, as low as possible.

The objective of the invention is the creation of a method for the determination of the viscosity of fluids of a simple structure but yielding exact measuring values, and of a viscosimeter usable for that purpose that, with a simple design, is usable for various measurements. In accordance with the invention, these objectives are achieved by a method of the kind mentioned at the beginning, with the characteristics mentioned in the attributes of Claim 1.

In accordance with the invention, the respective distance or the change in the distance between the two wall surfaces of the gap is measured. The change in the distance is caused by the pressure on the wall surfaces exerted by the fluid moved through the gap, which pressure is proportional to the shearing stress or, respectively, to the viscosity of the fluid to be examined. The distance materializing during the examination or, respectively, the change in the distance of the wall surfaces relative to an initial value, with temperature and rotation speed being known, are a measure for the pressure change in the measuring gap and thus for the dynamic viscosity of the examined fluid as well.

The examination of the fluid can be carried out advantageously in a gap running radially relative to the rotational axis of the rotating wall surface as well as in one running axially.

A preferred embodiment of the method in accordance with the invention results from the characteristics of Claim 2 and/or of Claim 3. The fluid to be examined is advantageously moved through the gap in the form of a laminar flow by the rotary motion, and the changes in the distance between the opposite wall surfaces caused by the pressure being created can be precisely recorded. Also, a sufficient flow through the gap is achieved in terms of its amount. The rotary speed is adjustable, thereby providing universal applicability.

The characteristics of Claim 4 are advantageous for a simple structure and precise measurements. The wall surface that is deflected or adjusted with regard to its distance is conveniently deflected against a reset force. This reset force having in particular an elastic characteristic should increase linearly together with the exerted pressure or, respectively, be dependent of it. The entire movement of the wall surface should be reversible in order to facilitate correspondingly comparable measurements.

A viscosimeter in accordance with the invention is characterized by the characteristics listed in the attributes of Claim 5. A robust viscosimeter in particular for in-line use is created thereby that permits precise measurements, that is of a simple structure, that is acid and pressure resistant due the appropriate choice of materials, and in which friction losses during the actuation of the rotating wall surfaces is completely without influence so that any expenditures for a loss-free bearing can be dispensed with. Sealing problems do not occur since no sealing of the viscosimeter in accordance with the invention is required. The viscosimeter is immersed in the fluid to be examined.

The characteristics of Claim 6 are realized in a preferred embodiment of this viscosimeter. The change in the distance between the rotating and the fixed wall surfaces can be very easily measured in this case. Also, such a viscosimeter can be positioned in the fluid to be examined without any major difficulties.

The characteristics of Claim 7 that permit precise measurements are realized in a preferred embodiment.

In order to create an accurately measuring viscosimeter, the embodiment in accordance with the characteristics of Claim 8 will be advantageous. It is possible to make the cylinder or, respectively, the cylinder shell relatively long in an axial direction, thereby creating a gap of corresponding width. This will result in a correspondingly high pressure in the interior of the gap that provides great measuring values that are easy to measure. Moreover, the fixed wall surface surrounding the rotating cylinder can be mounted elastically deformable and/or deviatable in a simple design. If the fixed wall surface is deformable or elastically deformable against a spring force, a linear correlation between the pressure exerted by the fluid and the reset force of the fixed wall surface will result. The characteristics of Claims 10 and/or 11 are analogously advantageous.

An advantageous length for the gap results from the characteristics of Patent Claim 9.

Precise measuring results will be obtained if the characteristics of Claims 12 and/or 13 are realized since they allow the measuring to occur as close to the rotating cylinder as possible. In this case, the measurement may occur between the two circumferential end areas of the fixed wall surface that approach each other or distance themselves from each other in accordance with the pressure in the interior of the gap.

A simple design of such a viscosimeter results from the characteristics of Claim 15. Here, the dimensions of the gap or, respectively, its tapering are particularly easy to adjust or, respectively, to alter by changing the eccentricity.

The characteristics of Claim 16 are realized in another preferred embodiment of the invention. This embodiment version possesses advantages with regard to its use in media in situ. For example, this viscosimeter can be used in fluids or, respectively, fluid lines and provides precise measuring results while having a stable structure.

The characteristics of Claim 17 facilitate an exact design of the gap. The gap can be designed through a corresponding design of the surface of the rotating wall surface or of the fixed wall surface. The fluid to be examined can be easily fed into the gap by using the characteristics of Claims 21 and 22. Design advantages and advantages improving the response behavior can be obtained using the characteristics of Claims 18, 19 and/or 20. Precise measuring results are obtained with the characteristics of Claim 25.

The rotating wall surface can be driven by a motor whose drive axle runs parallel to the rotational axis. In this context it may be advantageous if the component forming the rotating wall surface is actuated directly by the motor shaft.

For the accuracy of the measurements it will be advantageous if the gap tapers continuously. To this end, it will be possible to give the gap a wedge shape or to give one of the wall surfaces a curved, in particular a circular curved shape. It is advantageous to create in the gap between the rotating and the fixed wall surfaces a laminar flow of the fluid to be examined.

It will be particularly advantageous if the fixed wall surface is reversibly adjustable relative to a preferably elastic force or, respectively, reset force, in particular in its linear area of increase in force.

The characteristics of Claim 27 are advantageous. These characteristics make a simple conversion of a viscosimeter in accordance with the invention possible in order to be able to adjust or, respectively, convert the latter or, respectively, the examination of various fluid to varying environments.

All of these discussed characteristics contribute in each case to obtaining precise measuring results with the simply designed viscosimeters in accordance with the invention.

Measuring the distance between the rotating and the fixed wall surfaces can be done with different measuring systems, for example with eddy current sensors that are particularly well suited for measuring relative distance changes. Such a measurement can be done with corresponding high resolution or, respectively, accuracy. However, capacitive, inductive and/or optical, in particular interferometric, measuring devices and measuring methods for the determination of distance changes can be used as well. In particular, relative distance changes are measured. Absolute measurements can be avoided through appropriate calibration. A corresponding calibration of the viscosimeters in accordance with the invention follows; with regard to known standards, all influences through friction in the viscosimeter and through sealing and actuation problems are eliminated.

For carrying out the measurements, it is advantageous to know the revolution speed or, respectively, the frequency of the motor which is supposed to provide a constantly precise rotation speed. Moreover, it is advantageous if the temperature of the fluid can be precisely determined since the viscosity of fluid greatly depends on the temperature.

The viscosimeters in accordance with the invention are usable even under high pressure and temperatures since appropriate resistant materials can be utilized. The components forming the fixed wall surface and/or the rotating wall surface are suitably made of titanium, stainless steel or a nickel-based compound.

The thickness of the gap and/or the rotational speed are selected or, respectively, adjusted depending on the fluid to be examined. This is done in particular to provide a laminar flow-through.

In the following, the invention will explained exemplarily in detail by way of the drawing.

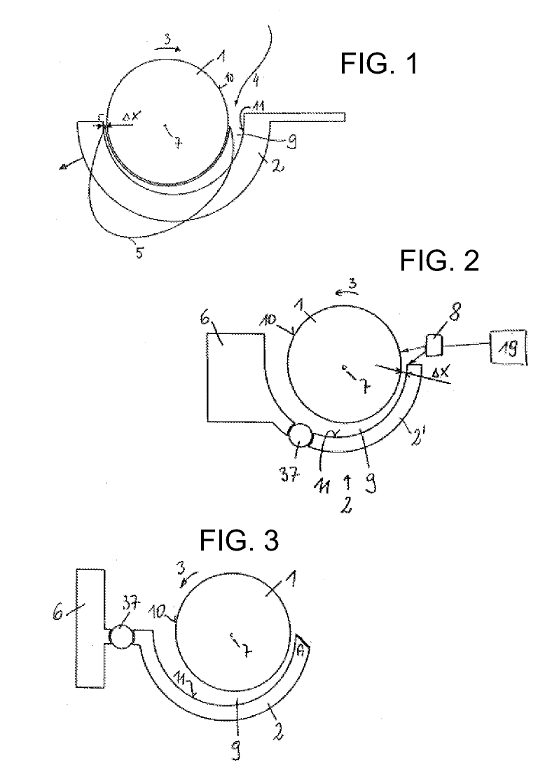

FIG. 1 shows the pressure build-up in a viscosimeter in accordance with the invention.

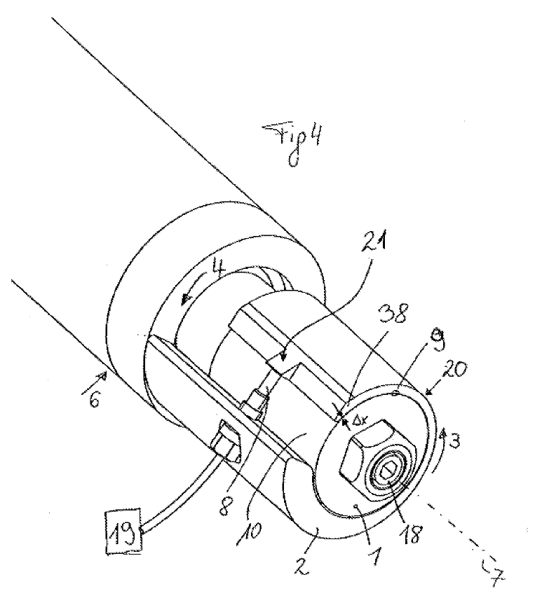

FIGS. 2 and 3 show schematically the functionality of an embodiment of a viscosimeter in accordance with the invention.

FIG. 4 shows a view of a first embodiment.

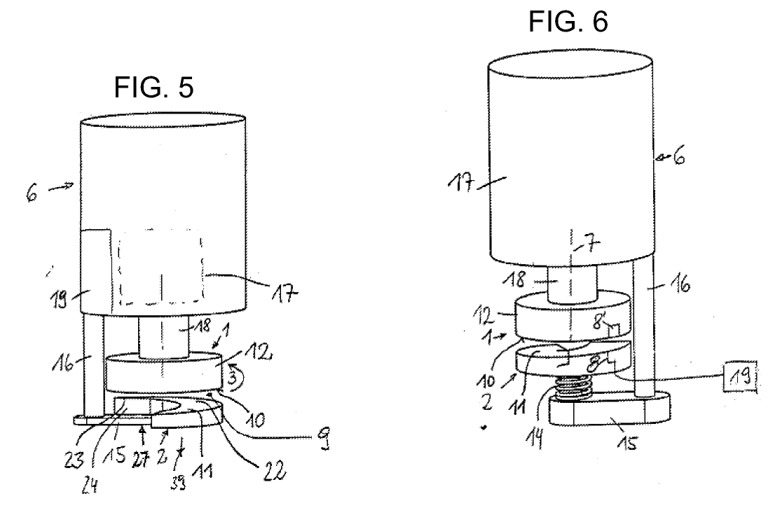

FIG. 5 and FIG. 6 show schematically a view of an additional embodiment of a viscosimeter in accordance with the invention.

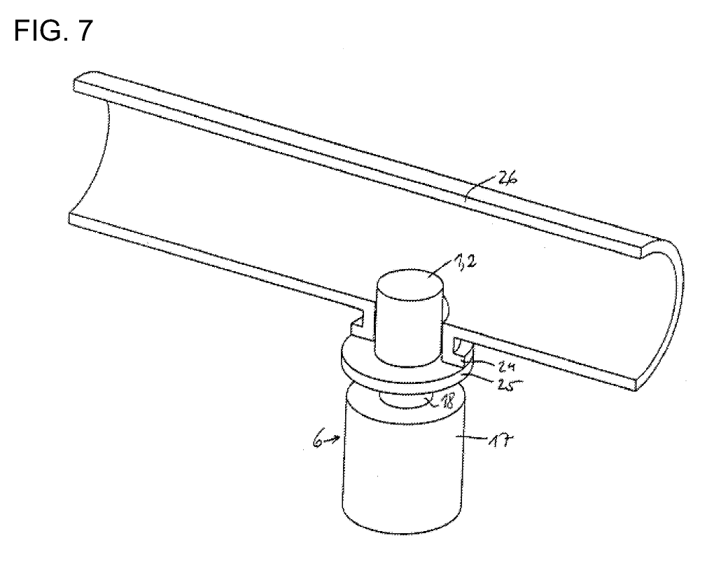

FIG. 7 shows an application option of a viscosimeter in accordance with the invention.

FIG. 1 shows a cut through a viscosimeter constructed in accordance with the invention. A gap is located between a component 1 that rotates around a central rotational axis 7 and which possesses a rotating circumferential surface or, respectively, a cylindrical wall surface, and a wall surface 11 formed on a component 2 which partially envelopes component 1. This gap advantageously has a uniform thickness across its width which runs parallel to the central rotational axis 7 but tapers in the rotational direction 3 of component 1.

4 designates the flow direction of a fluid not shown in detail which enters the gap 9 in the rotational direction 3 of the component 1 or, respectively, is transported into the gap 9 by the rotating surface 10. This fluid moved through the gap 9 exerts pressure on the wall surface 11 of component 2 whose course across the length of the gap 9 is designated by reference number 5. The pressure of the fluid appearing in accordance with curve 5 is based on the pressure created dynamically by the shearing strain of the fluid moved through the gap 9.

This pressure directed radially outward relative to the central rotational axis 7 causes a lifting of component 2 or, respectively, a distancing of the wall surface 11 from the rotating wall surface 10. The distance or, respectively, the change in the distance that appears is designated ΔX and serves as a measurement for the viscosity of the fluid moved through the gap 9.

It is advantageous to move the fluid through the gap in the form of a laminar flow and to adjust to this end the rotational speed of the rotating wall surfaces and/or the convergence of the gap and/or the course of the tapering of the gap and/or the thickness of the gap in such a way that this laminar flow can be achieved.

It is intended that the pressure of the fluid or, respectively, any change in the distance ΔX is countered by a reset force, in particular a reset force having an elastic or, respectively, reversible behavior. This accounts for the fact that the reset force remains proportional to the pressure exerted by the fluid even under changing pressure or, respectively, differing deflections of component 2 relative to component 1. A resetting of component 2 is brought about either by its elastic behavior and/or by a mechanic or electrical or magnetic reset force.

FIG. 2 shows an embodiment in which component 2 is mounted rotatably on a stationary carrier or housing 6 against the effect of a spring which is represented schematically as a spring-loaded joint 37. Moreover, the front or, respectively, free end section 2′ of component 2 can perform an elastic deflection in a plane vertical to the central rotational axis 7.

FIG. 3 shows an embodiment of a viscosimeter in which component 2 is mounted on the housing 6 by means of a spring joint that makes a deflection in a plane vertical to the central rotational axis 7 possible.

As can be seen in FIGS. 1 and 3, it is intended that component 1 forming the rotating wall surface 10 is formed by a rotating cylinder or, respectively, cylinder shell, with component 2 forming the fixed wall surface which, in particular, represents a part of a cylinder shell, enveloping the rotating cylinder or, respectively, the cylinder shell across a predetermined section of the cylinder circumference, thereby forming the gap 9.

It is advantageous that the fixed wall surface 11 envelopes the rotating wall surface across a circumference of 180° to 340°, in particular of 270° to 330°. However, it is also possible to envelop the rotating wall surface 10 with the fixed wall surface 11 across a lesser circumference.

Furthermore, a measuring unit 8 is provided that measures the distance or, respectively, the change in the distance ΔX, particularly of the end section, of the fixed wall surface 11 relative to the rotating wall surface 10 in a direction tangential to the circumference of the rotating wall surface 10. This measuring unit 8 can be attached to a central evaluation unit 19 in which central evaluation unit 19 the incoming signals concerning completed distance changes can be compared with the results of calibration measurements, thereby allowing a statement concerning the viscosity of the fluid to be examined.

FIG. 4 shows schematically a view of a first embodiment of a viscosimeter with a housing 6 in which an electric motor not visible in detail is accommodated on whose shaft a cylindrical component 1 is arranged. Attached to the housing 6 is a plate-shaped component 2 whose thickness tapers in the circumferential direction or, respectively, the rotational direction 3 of the component 1, enveloping the latter and thereby forming the gap 9. This component 2 formed by a bent plate 20 is permanently attached to the housing 6. The fluid to be examined can enter as shown by the arrow 4. The plate-shaped component 2 is pushed away from the cylindrical component 1 by the fluid being moved through the gap; in particular, the end section 38 of component 2 distances itself by an amount ΔX from the surface 10 of the rotating cylinder 1. The movement of the end section 38 relative to the front section of component 2 attached to the housing 6 can be measured with a measuring device 8 that, for example, abuts or reaches an edge or a projection of the end section 38 of component 2. This change in the distance may be regarded as a measure of the viscosity of the fluid moved through the gap 9. The central evaluation unit 19 is attached to the measuring device 8.

FIG. 5 shows an embodiment of a viscosimeter in which a motor indicated schematically with 17 is located in a housing 6; a component 1 having the shape of a cylinder 12 is arranged in the shaft of the motor. This component 1 has an end plane that is rotated around the rotational axis 7 of the shaft. This end plane forms a rotating wall surface 10 which lies opposite a surface path 22 that functions as a fixed wall surface 11. The surface path 22 is formed onto component 2. As a rule, one of the two wall surfaces 10, 11, in particular the fixed wall surface 11 opposite the rotating wall surface 10, is equipped with the helicoid-like surface path 22 rising in the rotational direction 3 of the rotating surface 10.

As an advantage, it may be provided that the surface path 22 extends on the preferably circular wall surface 10 or 11 across a sector at an angle of 180° to 340°, preferably 270° to 330°.

A fluid to be examined is entered into the gap 9 formed between component 1 and component 2 by means of the rotation of the rotating wall surface 10, and component 2 is pressed away from component 1 in the direction of the arrow 39 due to the developing pressure. This displacement can be measured by a deformation of the carrier 15 on which component 2 is mounted; this deformation can be determined for example with a rotation measuring strip. There is also the possibility per se to make the carrier 16 rigid and to measure the distance between component 1 and component 2 with a measuring unit 19, for example a motion or path sensor which is located in the housing 6 and measures the movement of the carrier 16.

In this embodiment, it is advantageous for the feed of the fluid into the gap 9 if a free area 24 sloping essentially abruptly or, respectively, vertically to the surface of the component and, if necessary, a free space 27 adjacent to it, are formed adjacent to the surface path 22, preferably to the fixed wall surface 11, in particular at the narrowest part 23 of the gap.

Good measuring results are obtained if the helicoid-like surface web 22 is formed on the end face of a circular cylinder or circular cylinder ring or circular cylinder sector or circular cylinder ring sector.

An alternative to the embodiment of FIG. 5 is shown in FIG. 6. In this embodiment, component 2 is mounted on the carrier 15 against the effect of a spring 14. The distance measuring occurs by measuring the distance between components 1 and 2 using a measuring device 8 which is arranged on component 2 and, if need be, supports a measuring part 8′ on component 1 that interacts with it.

It will be advantageous if component 1 forming the rotating wall surface 10 is directly actuated by the motor shaft 18 or, respectively, if component 1 forming the rotating wall surface 10 is mounted detachably or, respectively, exchangeably on the motor shaft 18 and/or component 2 forming the fixed wall surface 11 is mounted detachably or, respectively, exchangeably on the motor housing 4 or a carrier 6 common to the rotating component 10 [part of this sentence is unintelligible]. This makes it easy to adjust the viscosimeters to varying operating conditions or, respectively, to different fluids to be examined.

For precise measuring results it is advantageous if the gap tapers steadily or, respectively, if the gap is wedge-shaped or if at least one wall surface 10, 11, preferably the fixed wall surface 11, is curved, in particular in a circular shape or in the form of a sinus wave or, respectively, if the measuring unit 8 for the measurement of the distance or, respectively, the change in the distance ΔX between the rotating wall surface 10 and the fixed wall surface 11 is arranged in the area of the end section 23 of the fixed wall surface 11 or, respectively, in the area of the narrowest point of the gap 9.

FIG. 7 shows a viscosimeter in accordance with the invention in operation for the measurement of the viscosity of a fluid flowing through a pipe 26. The viscosimeter is attached by a flange 25 to a flange 24 of the pipeline 26 and extends with its rotating component 1 as well as with component 2 enveloping this rotating component 1 into the interior of the pipe as shown schematically in FIG. 7. In this way, it is easy to conduct in situ examinations with the viscosimeter in accordance with the invention.

The decrease in thickness across the length of the gap may be continuous or discontinuous, but the formation of a laminar flow is essential. A steady tapering is advantageously provided. In principle, both wall surfaces of the gap could have the same or different curvatures or, respectively, surface courses. The wedge angle can be selected at will—within limits predetermined by the practice—for the formation of a laminar flow.

Advantageous for the execution of the measurements is the repeatability of the deflection and the reset force caused thereby which should be defined and reversible. The reset force may be linear or non-linear, depending on the properties of the structural components or materials used for the resetting. A linear correlation between the deflection of the movable wall surface and the rest force would be advantageous.

1-31. (canceled)

32. A method for determining a viscosity of fluids, including liquids, which comprises the steps of:
bringing a fluid into and moved through a gap, selected from the group consisting of a continuously tapering gap and a narrowing gap, bounded by two opposite wall surfaces;
measuring one of a distance between the two opposite wall surfaces and a change in a distance between the two opposite wall surfaces on a basis of pressure exerted on the two opposite wall surfaces by the fluid moved through the gap resulting in a measured value; and
evaluating the measured value for ascertaining the viscosity of the fluid.

33. The method according to claim 32, which further comprises rotating one of the two opposite wall surfaces defining the gap around a central rotational axis, with the fluid to be examined being fed by means of a rotational motion into an interior space of the gap or, being moved through the gap in a form of a laminar flow, with a rotational speed of the rotating wall surface being taking into account and adjusting one of a convergence of the gap, a course of a tapering of the gap, and a thickness of the gap such that the laminar flow of the fluid to be examined is created in the gap.

34. The method according to claim 33, which further comprises evaluating one of the distance and the change in the distance appearing between a rotating wall surface and a fixed wall surface which is fixed relative to the rotating wall surface but distance-adjustable as a measuring value for the viscosity of the fluid.

35. The method according to claim 32, which further comprises counteracting one of the pressure of the fluid and, any change in the distance by a reset force exerted on one of the wall surfaces, the reset force causing one of an elastic resetting of the wall surfaces and a reversible resetting of the wall surfaces.

36. A viscosimeter for determining viscosity of fluids, including liquids, the viscosimeter comprising:
two opposite wall surfaces defining a gap there-between, the gap selected from the group consisting of a tapering gap and a narrowing gap, a fluid being fed into said gap bounded by two said opposite wall surfaces and being moved through said gap, said two opposite wall surfaces including a fixed wall surface and a rotating wall surface executing a rotational motion rotating around a central axis relative to said fixed wall surface;
a measuring unit for recording one of a respective distance between said two opposite wall surfaces and a change in a distance between said two opposite wall surfaces due to pressure exerted by the fluid being moved through said gap resulting in a measured value; and
an evaluation unit connected to said measuring unit and receiving the measured value for determining the viscosity of the fluid.

37. The viscosimeter according to claim 36,
further comprising a first component forming said rotating wall surface and rotating around said central axis;
further comprising a second component forming said fixed wall surface being disposed opposite said rotating wall surface and is one of mounted, disposed and formed adjustably in terms of distance against a reset force acting one of elastically and reversibly; and
wherein said measuring unit measuring one of the distance and the change in the distance between the rotating wall surface and the fixed wall surface.

38. The viscosimeter according to claim 37, wherein:
said first component forming said rotating wall surface is one of a rotating cylinder and a cylinder shell; and
said fixed wall surface envelops one of said rotating cylinder and said cylinder shell across a predetermined section of a cylinder circumference, thereby forming said gap.

39. The viscosimeter according to claim 36,
further comprising a component selected from the group consisting of a cylinder and a cylinder shell, said fixed wall surface is formed onto said component which is mounted in a plane vertical to said rotational axis of said rotating wall surface, said component being at least one of rotatably deformable and elastically deformable in sections against one of a predetermined force and a reset force at least with or, respectively, across a part or parts; and
wherein said measuring unit measures at least one of a deviation path and a deformation of said fixed wall surface or, respectively, of sections or, respectively, of the change in the distance between said cylinder or, respectively, said cylinder shell and said fixed wall surface or, respectively, their segments.

40. The viscosimeter according to claim 36, wherein said fixed wall surface envelopes said rotating wall surface across a circumference of 180° to 340°.

41. The viscosimeter according to claim 38,
further comprising a supporting unit selected from the group consisting of a carrier and a housing;
further comprising a spring connected to said supporting unit; and
wherein said second component forming said fixed wall surface being rotatably mounted on one of said carrier and said housing supporting one of said rotating cylinder and said cylinder shell in a plane vertical to said rotational axis against an effect of said spring, or, respectively, has at least a section, including an end section, pivoting in a plane elastically against an effect of said spring.

42. The viscosimeter according to claim 38, wherein said second component forming said fixed wall surface being one of elastically flexible and expandable in a plane vertical to said rotational axis of one of said rotating cylinder and said cylinder shell, said second component being a plate bent around one of said rotating cylinder and said cylinder shell in a cylindrical shape and decreases in thickness in a direction of said tapering of said gap.

43. The viscosimeter according to claim 36, wherein said measuring unit measures in a direction tangential to a circumference of said rotating wall surface one of the distance and the change in the distance of said fixed wall surface relative to said rotating wall surface.

44. The viscosimeter according to claim 38, wherein:
said fixed wall surface has an end section;
said second component has a front section; and
said measuring unit is supported by said front section of said second component and measures one of a distance of said front section and a change in a distance relative to said end section of said fixed wall surface one of led and bent around said rotating cylinder.

45. The viscosimeter according to claim 44, wherein said fixed wall surface forms an acute angle together with an end surface of said second component in a front section of said gap.

46. The viscosimeter according to claim 38, wherein said fixed wall surface has a circular cylindrical interior cross section and an axis that is disposed eccentrically relative to said central axis of one of said rotating cylinder and said cylinder shell to form said gap being a converging gap.

47. The viscosimeter according to claim 38, wherein:
said rotating wall surface is formed by a rotating circular surface, being an end surface of a rotatable cylinder;
said fixed wall surface is disposed opposite, and parallel to, said rotating circular surface, thereby forming said gap;
said fixed wall surface is one of elastically and reversibly pre-stressed and loaded with a pre-determined force in a direction of an end surface, and counteracts any pressure charge exerted by the fluid to be examined; and
said measuring unit measures one of the distance and the change in the distance between said two wall surfaces.

48. The viscosimeter according to claim 47, wherein said fixed wall surface disposed opposite said rotating wall surface forms a helicoid-shaped surface path rising in a rotational direction of the rotating circular surface.

49. The viscosimeter according to claim 48, wherein said helicoid-shaped surface path extends on a preferably circular wall surface across a sector at an angle of 180° to 340°.

50. The viscosimeter according to claim 47, wherein said second component forming said fixed wall surface is spring-loaded in a direction of said end surface.

51. The viscosimeter according to claim 47, wherein said first and second components one of bearing and forming said end surface and said fixed wall surface have a same diameter.

52. The viscosimeter according to claim 47, wherein one of said first and second components defining an open area one of dropping abruptly and vertically to a surface of said first and second components and said open area is formed adjacent to said helicoid-shaped surface path.

53. The viscosimeter according to claim 48, wherein:
said fixed wall surface is selected from the group consisting of a circular cylinder and a circular cylinder ring; and
said helicoid-shaped surface path is formed on one of an end surface of said circular cylinder, an end surface of said circular cylinder ring, a circular cylinder sector of said circular cylinder and a circular cylinder ring sector of said circular cylinder ring.

54. The viscosimeter according to claim 37, further comprising a motor having a drive axle, said rotating wall surface being driven by said motor and said drive axle runs parallel to said central axis.

55. The viscosimeter according to claim 54, wherein said first component is directly driven by said drive axle.

56. The viscosimeter according to claim 38, wherein said measuring unit for measuring one of the distance and the change in the distance between said rotating wall surface and said fixed wall surface is disposed one of in an area of an end section of said fixed wall surface and in an area of a narrowest point of said gap.

57. The viscosimeter according to claim 37, wherein said first and second components forming said fixed wall surface and said rotating wall surface are made from a material selected from the group consisting of titanium, stainless steel and a nickel-based alloy.

58. The viscosimeter according to claim 54,
further comprising a motor housing;
further comprising a common support;
wherein said first component forming said rotating wall surface is mounted one of detachably and exchangeably on said drive axle; and
wherein said second component forming said fixed wall surface is mounted one of detachably and exchangeably on one of said motor housing and said common support with said rotating component.

59. The viscosimeter according to claim 36, wherein said gap tapers steadily.

60. The viscosimeter according to claim 36, wherein said gap is formed in a wedge shape with smooth running wall surfaces.

61. The viscosimeter according to claim 36, wherein the laminar flow of the fluid to be examined is formed in an insert in said gap between said rotating wall surface and said fixed wall surface.

62. The viscosimeter according to claim 36, wherein said fixed wall surface is reversibly adjustable against one of an elastic force and a reset force in its area of linear force increase.

63. The viscosimeter according to claim 40, wherein said fixed wall surface envelopes said rotating wall surface across said circumference of 270° to 330°.

64. The viscosimeter according to claim 38, wherein said fixed wall surface is a part of a cylinder shell.

65. The viscosimeter according to claim 36, wherein said measuring unit measures in a direction tangential to a circumference of said rotating wall surface one of the distance and the change in the distance in an end section of said fixed wall surface relative to said rotating wall surface.

66. The viscosimeter according to claim 36, wherein said fixed wall surface is one of circularly curved and sinusoidal.

67. The viscosimeter according to claim 48, wherein said helicoid-shaped surface path extends on a preferably circular wall surface across a sector at an angle of 270° to 330°.

68. The viscosimeter according to claim 52, wherein said open area is formed in said fixed wall surface and in an area of a narrowest part of said gap.
